(19) United States
(12) Patent Application Publication
(10) Pub. No.: US 2005/0058396 A1
(43) Pub. Date: Mar. 17, 2005

(54) Nested function ring resonator

(76) Inventors: Maurizio Tormen, Milano (IT); Hermann A. Haus, Lexington, MA (US); Eleanor L. Haus, Lexington, MA (US)

Correspondence Address: Samuels, Gauthier & Stevens LLP, Suite 3300, 225 Franklin Street, Boston, MA, 02110, US

(21) Appl. No.: 10/663,544

(22) Filed: Sep. 15, 2003

(51) Int. Cl. G02B 6/26

(52) U.S. Cl. 385/39; 385/27

(57) ABSTRACT

An optical filter includes at least one ring resonator that receives as input an optical signal having a plurality of channels from an input optical source. At least one Mach-Zehnder module is nested in the at least one ring resonator. The at least one Mach-Zehnder module and the at least one ring resonator filter at least one selective channel from the optical signal.

### BACKGROUND OF THE INVENTION

The invention relates to the field of ring resonators, and in particular to a nested function ring resonator performing filtering operations.

Rings and disk resonators fabricated on optical substrates have been investigated theoretically and experimentally for their potential use in optical signal processing applications. It is desirable for the ring or disk dimensions to be as small as possible, so that the free spectral range of the resonances is large. In order to have high Free Spectral Range Filter made with optical rings, usually a very small bending radius and high index contrast are required.

The paper “An optical filter of adjustable finesse using a Mach Zehnder interferometer”, by Y. H. Chew et al, SINGAPORE ICCS '94 Conference Proceedings, 14-18 Nov. 1994, vol. 1, pp. 70-72, discloses that by adjusting the phase difference between the two arms of a Mach Zehnder interferometer inserted in the feedback path of a simple ring resonator, the finesse of an optical filter can be easily controlled over a specified range. According to the authors, the filter will be useful in coherent optical systems employing laser diodes, where the bandwidth has to be adjusted under varying biasing and signaling conditions. In the arrangement described in the cited paper, the two directional couplers that form the MZ interferometer are assumed to have equal coupling coefficients and equal lengths for both the reference and sensing arms under unbiased condition. Accordingly, the MZ interferometer is a balanced interferometer.

### SUMMARY OF THE INVENTION

The present invention disconnects the deep relationship between achievable FSR and bending radius, allowing independent choices for both of them.

The introduction of an interferometric device along the path of a ring resonator can introduce new degrees of freedom in tailoring the response of the resonator. It is found that an unbalanced interferometer, such as an unbalanced Mach-Zehnder interferometer (MZI) generates a frequency dependent response that can be tailored, if the unbalanced interferometer is introduced along the resonating path of a ring resonator, to enhance resonance at one or more selected frequencies and at the same time to hinder resonance at some other of the frequencies that would otherwise resonate in the ring resonator if the interferometric device was absent.

According to one aspect of the invention, there is provided an optical filter. The optical filter includes at least one ring resonator that is apt to receive as input an optical signal having a plurality of channels from an input optical source. At least one unbalanced Mach-Zehnder module is nested in the at least one ring resonator, wherein the at least one unbalanced Mach-Zehnder module and the at least one ring resonator are apt to filter at least one selective channel from the optical signal.

According to another aspect of the invention, there is provided an optical filter. The optical filter includes a plurality of filter arrangements including at least one ring resonator that is apt to receive as input an optical signal having a plurality of channels from an input optical source. At least one unbalanced Mach-Zehnder module is nested in the at least one ring resonator, wherein the at least one unbalanced Mach-Zehnder module and the at least one ring resonator are apt to filter at least one selective channel from the optical signal.

According to another aspect of the invention, there is provided a method of optical filtering. The method includes providing at least one ring resonator that receives as input an optical signal having a plurality of channels from an input optical source. The method includes providing at least one unbalanced Mach-Zehnder module nested in the at least one ring resonator. The at least one unbalanced Mach-Zehnder module and the at least one ring resonator filter at least one selective channel from the optical signal.

According to another aspect of the invention, there is provided a method of optical filtering. The method includes providing a plurality of filter arrangement including at least one ring resonator that receives as input an optical signal having a plurality of channels from an input optical source. The method also includes providing at least one unbalanced Mach-Zehnder module nested in the at least one ring resonator. The at least one unbalanced Mach-Zehnder module and the at least one ring resonator filter at least one selective channel from the optical signal.

### BRIEF DESCRIPTION OF THE DRAWINGS

FIG. 1 is a schematic diagram of filtering device in accordance with the invention;

FIG. 2 is a schematic diagram of an unbalanced Mach-Zehnder Interferometer (MZI) used in accordance with the invention;

FIG. 3 is a schematic diagram of a MZI structure incorporated into a ring resonator;

FIGS. 4A and 4B are comparison graphs of the throughput and drop port behavior of a filtering device including a simple ring resonator, without a MZI structure;

FIGS. 4C and 4D are graphs of the throughput and drop port behavior of the inventive filter;

FIGS. 5A-5C are schematic diagrams of a filter arrangement having one interferometric device;

FIG. 6 is a schematic diagram of a cascaded MZI structure;

FIGS. 7A-7C are schematic diagrams of various positions to place two or more interferometric devices for use as a filter;

FIG. 8 is a schematic diagram of another filter arrangement used in accordance with the invention;

FIGS. 9A-9C are schematic diagrams of a switchable and tunable filter arrangement;

FIG. 10 is a schematic diagram of another embodiment of a switchable and tunable filter arrangement;

FIG. 11 is a schematic diagram of a second embodiment of the switchable and tunable filter arrangement;

FIG. 12 is a schematic diagram of a first embodiment of the switchable and tunable laser; and

FIG. 13 is a schematic diagram of a second embodiment of a switchable and tunable laser arrangement.

### DETAILED DESCRIPTION OF THE INVENTION

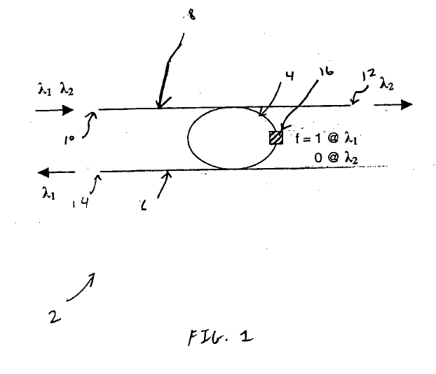

FIG. 1 is a schematic diagram of an inventive filtering device 2. The filtering device 2 includes an input port 10, a throughput port 12, a ring resonator 4, and a drop port 6. Also, the filtering device 2 includes two bus lines 6, 8. The first bus line 8 couples the input port 10 to the throughput port 12, and the second bus line 6 is coupled to the drop port 14. The input port 10 receives channels λ₁ and λ₂. However, in other embodiments, there can be more channels at the input port 10. The throughput port 12 outputs the channel λ₂, and the drop port 14 outputs the channel λ₁. An optical coupler couples light between first bus line 8 and ring 4. A further optical coupler couples light between ring 4 and second bus line 6. Preferably both couplers have the same coupling ratio.

Moreover, the filtering device 2 is a ring-based device that includes an apparatus 16 along the ring 4 as shown in FIG. 1, and operates on different wavelengths according to a desired function. According to the invention, the apparatus 16 transmits the optical channel λ₁ and cancels or leads out of resonance the channel λ₂. The advantage of such approach is in that the “Free Spectral Range” (FSR) of the filtering device 2, i.e., the frequency spacing between adjacent transmission maxima, is increased in respect to a simple ring resonator. In particular, the FSR range of the whole filter will not simply be the FSR of the ring itself.

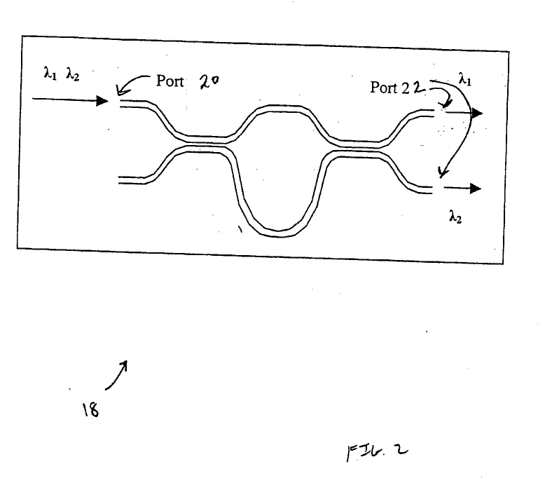

FIG. 2 is a schematic diagram of an unbalanced Mach-Zehnder Interferometer (MZI) used in accordance with the invention.

The MZI structure includes two ports 20, 22 and two optical couplers. The optical couplers are preferably 3 dB (i.e., 50%) couplers. The first port 20 receives channels λ₁ and λ₂ and the second port 22 includes two outputs. In particular, the second port 22 can output the channels λ₁ and λ₂ separately or phase shift them differently. The second port 22 can accordingly separate the channels of the first port 20 or give them a different phase shift. While a balanced MZI interferometer would have a transmission response substantially independent from wavelength, the real part of the transmission at second port 22 for an unbalanced interferometer as used in the invention varies sinusoidally with respect to frequency and is calculated as:
f=sin (k·Δ1) Eq. 1

where k=2π/λ and Δ1 is the path difference between the arms of the unbalanced MZI structure. The unbalance of the MZI structure, i.e., the path length difference Δ1, is such that the MZI structure has a Free Spectral Range lower than the bandwidth of interest. In practice, the unbalance Δ1 should be of at least 500 nm. The specific value of unbalance Δ1 is selected as a function of the spectral response of the filter, in particular with a view to adjust the spectral response of the MZI so as to selectively suppress resonance for some of the peaks that would otherwise resonate in the simple ring without MZI. While different values of unbalance may be appropriate from a spectral point of view, a longer unbalance may be advantageous from a technological point of view. Typical preferred values are, e.g, included in the range from 50 to 500 μm. otherwise resonate in the ring resonator if the unbalanced interferometer was absent.

The MZI structure 18 essentially performs the tasks of splitting out the channels λ₁ and λ₂ and supplying them to separate ports or it can be operated such that the acquired phase is different for different channels. Thus, one can access a selective channel from an input comprising a plurality of channels.

In greater detail, one possible set up for the unbalanced MZI structure within the ring resonator is to dimension it so that f=1 at λ₁ and f=0 at λ₂. In this case the MZI structure transmits the optical channel λ₁ at port 22 substantially without attenuation while substantially blocking the optical channel λ₂ at the same port 22.

In a second, preferred, set-up, the MZI structure is dimensioned so that f=1 at λ₁ and f=−1 at λ₂. In this case, the MZI structure transmits the optical channel λ₁ at port 22 substantially without attenuation, while the optical channel λ₂ is phase shifted at port 22 so as to substantially prevent its resonance within the ring. This second set-up can lead to a better cancellation of the resonance at λ₂ within the ring resonator and, accordingly, to a better rejection performance for the whole filter.

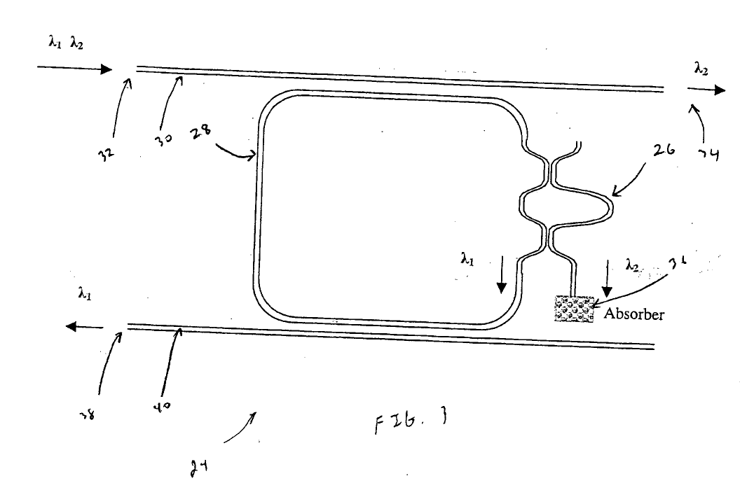

FIG. 3 is a schematic diagram of a filter 24 including an unbalanced MZI structure 26 incorporated into a ring resonator 28. The ring resonator 28 is a standard ring resonator. However, the unbalanced MZI structure 26 is embedded in the ring structure 28. The embedded MZI structure 28 performs the same task as that described in FIG. 2. The main bus line 30 includes a throughput port 34 and an input port 32 that also receives channels λ₁ and λ₂. Moreover, the ring resonator 28 receives the channels λ₁ and λ₂ and performs the filtering described above by using an absorber 36 at the output of channel λ₂. In this way only λ₁ can resonate in the ring, while λ₂ cannot. In other embodiments, a power monitor can be used in place of the absorber 36 so that the proper functionality of the whole device can be tested.

The ring resonator provides to the drop port 38 on bus line 40 the channel λ₁, and the channel λ₂ is allowed to proceed on to the throughput port 34.

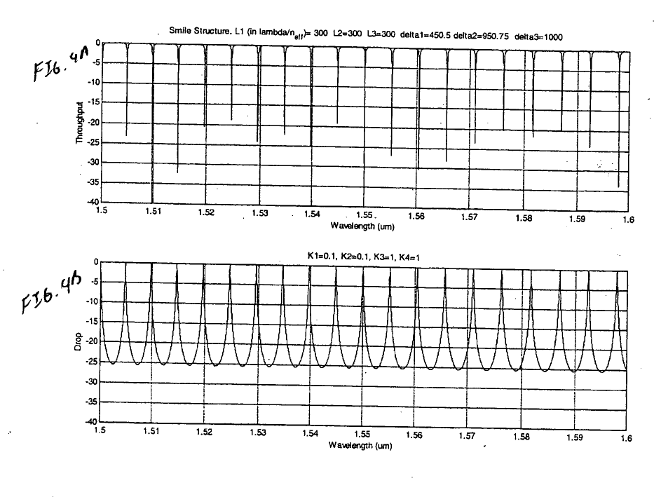

FIGS. 4C and 4D are graphs of the throughput and drop port behavior of the inventive filter 24. In this embodiment, the power couplings of the coupler between main bus line 30 and ring 28, and of the coupler between ring 28 and bus line 40 are 0.1 and 0.1, respectively. The optical path length of ring 28 is 258 μm. The path length unbalance of MZI structure 26 is 387 μm. FIG. 4C is a graph demonstrating the behavior at the throughput port, and FIG. 4D shows the drop port behavior of the inventive filter.

For comparison purposes, FIGS. 4A and 4B show graphs of the throughput and drop port behavior of a filter device with characteristics as in the above embodiment, but including a simple ring resonator, i.e., without a MZI structure embedded in it. Note that the inventive filter 24 is not just a resonant cavity, but it is a resonant-interferometric device. Thus, at certain frequencies the drop function is equal to zero. Several peaks in the drop function are suppressed in respect to the case of the simple ring. This occurs not only at channels where the MZI structure has barred transmission. Even if the power suppression is relatively small at some wavelengths per each pass in the ring, the overall suppression can be significant.

However, the suppression in the drop port for unwanted channels may still not be sufficient. There are several ways to address this problem, which will be described hereinafter. Also, there may be unwanted losses associated with the throughput port. Hereinafter, a possible approach for eliminating it will be described also.

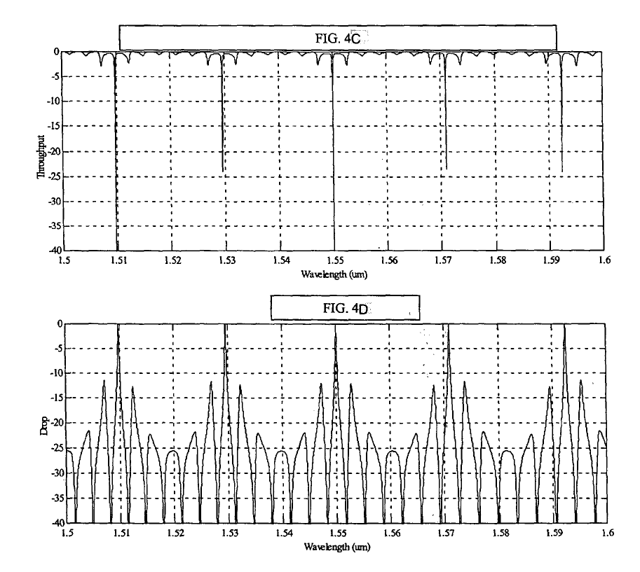

FIGS. 5A-5C are schematic diagrams of a filter arrangement having one interferometric device. FIG. 5A shows a filter arrangement 42 having three ring resonators 48 and one interferometric device 50. The interferometric device 50 is positioned on the right side of the first ring resonator 52, downstream of ring input coupler 51. The input port 54 receives channels λ₁, λ₂, and λ₃. Under this arrangement, the residual power of the undesired λ at a further coupler 53 along the first ring is reduced, and thus is expelled by the interferometer.

FIG. 5B shows a filter arrangement 44 having three ring resonators 56 and an interferometric device 58. The interferometric device 58 is positioned on the left side of the center ring resonator 62. The input port 60 receives channels λ₁, λ₂, and λ₃. Under this arrangement, the losses associated with the interferometric device 58 in the center ring 62 can be less than in the former case of FIG. 5A.

FIG. 5C shows a ring resonator arrangement 46 having three ring resonators 64 and an interferometric device 66. The interferometric device 66 is positioned on the right side of the bottom most ring resonator 68. The input port 70 receives channels λ₁, λ₂, and λ₃. Under this arrangement, the losses associated with interferometric device 66 being on the bottom most ring 68 are higher than in the previous case and comparable with the case of FIG. 5A.

Moreover, FIGS. 5A-5C demonstrate in each of the three cases that the interferometric device is placed just before the junction (coupler) between that ring and the next (in respect to light propagation direction) to prevent the coupling of undesired λ to the next ring. However, this improvement is only important if the unbalanced MZI structure is set-up so as to transmit one channel and block another channel, and thus there is no preclusion in general to positioning the interferometric device just after the junction.

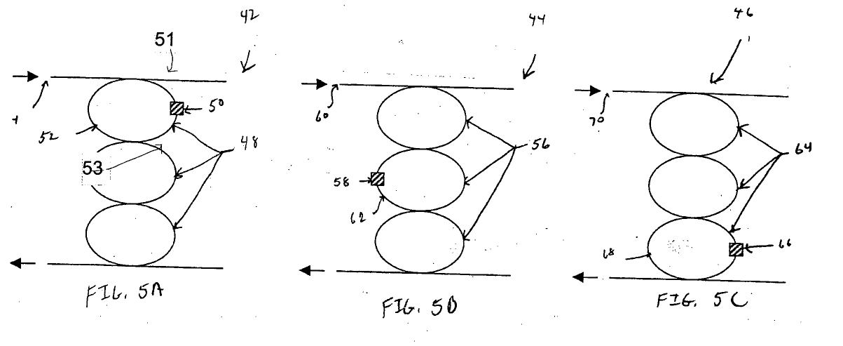

FIG. 6 is a schematic diagram of a possible nested unbalanced MZI structure 72. The nested MZI structure 72 is comprised of two unbalanced MZI structures 74, 76 that are cascaded one immediately after the other. Moreover, the nested unbalanced MZI structure 72 includes an input port 78 that receives three channels λ₁, λ₂, and λ₃. The path length difference between the two arms of the first MZI structure 74 is Δ1₁ and the path length difference between the two arms of the second unbalanced MZI structure 76 is Δ1₂. The first MZI structure 74 is coupled to the second MZI structure 76 at the point 82, which permits both channels, λ₁ and λ₃ to continue passing the nested MZI structure 72. However, channel λ₂ is dropped by the nested MZI structure 72. At the second MZI structure 76, the channels λ₁ and λ₃ are separated and provided as distinct outputs. This allows further filtering to occur, where either λ₁ or λ₃ are absorbed using a device, such as an absorber. In other embodiments, either λ₁ or λ₃ can also be removed at the first MZI structure 74.

In order to increase the FSR, it is possible to arrange appropriately the individual FSR for the cavity and interferometer. It is also possible to modify the real part of the transmission function of the interferometer, which can be
f=sin (k·Δ1₁)·sin (k·Δ1₂) Eq. 2

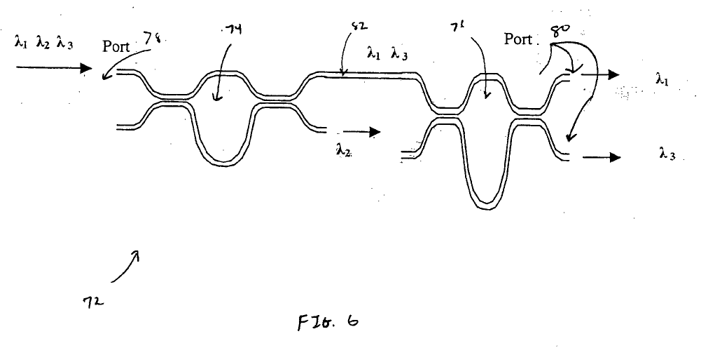

FIGS. 7A-7C are schematic diagrams of various positions to place two interferometric devices for use as a filter. FIG. 7A shows a filter arrangement 84 having three ring resonators 90 and two unbalanced interferometric devices 92, 94. The interferometric devices 92, 94 are positioned on the right side of the ring resonator 96.

FIG. 7B shows a ring resonator arrangement 86 having three ring resonators 98 and two unbalanced interferometric devices 100, 102. The interferometric devices 100, 102 are positioned on the left side of the center ring resonator 104 and on the right side of the bottom most ring resonator 106.

FIG. 7C shows a ring resonator arrangement 88 having three ring resonators 108 and three unbalanced interferometric devices 110, 112, 114. The interferometric devices 110, 112, 114 are positioned on the left side of the center ring 116 resonator and on the right side of the bottom most ring resonator 118.

It is not necessary for two interferometric devices to be cascaded one immediately after the other.

In the previous embodiments various combinations of ring resonators and unbalanced interferometric devices are shown. Any number of coupled ring resonators, such as one, two, three or greater can be used, and at least one of the ring resonators is to be provided with an unbalanced interferometer along its path. In a preferred embodiment, an unbalanced MZI is included in each one of the coupled ring resonators. The greater the number of ring resonators and/or unbalanced interferometers, the higher the order of the filter for the resulting filter device.

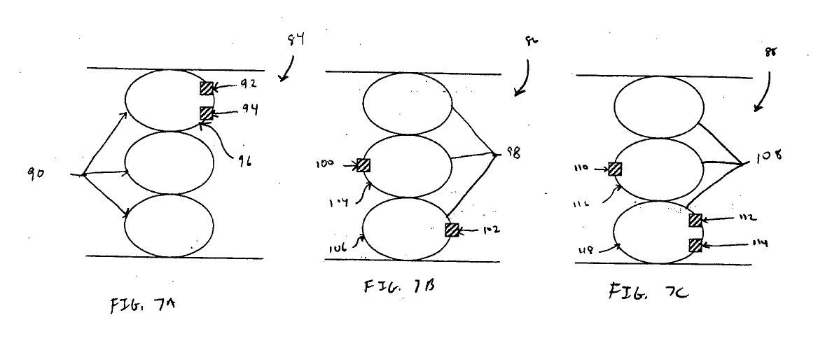

FIG. 8 is a schematic diagram of another filter arrangement 120 used in accordance with the invention. The filter arrangement 120 includes a ring resonator 122 with a nested unbalanced MZI 124 that has the two couplers 126 on the opposite arms of the ring 124 itself. The ring resonator 122 is a standard ring resonator, the unbalanced MZI interferometer is constituted by part of the ring 122 and by arm 124, which also includes an absorber 125. In addition, the filter arrangement 120 includes a main bus line 126 having an input port 128 and throughput port 130. The spectral behavior of this filter is similar to the filter shown in FIG. 3.

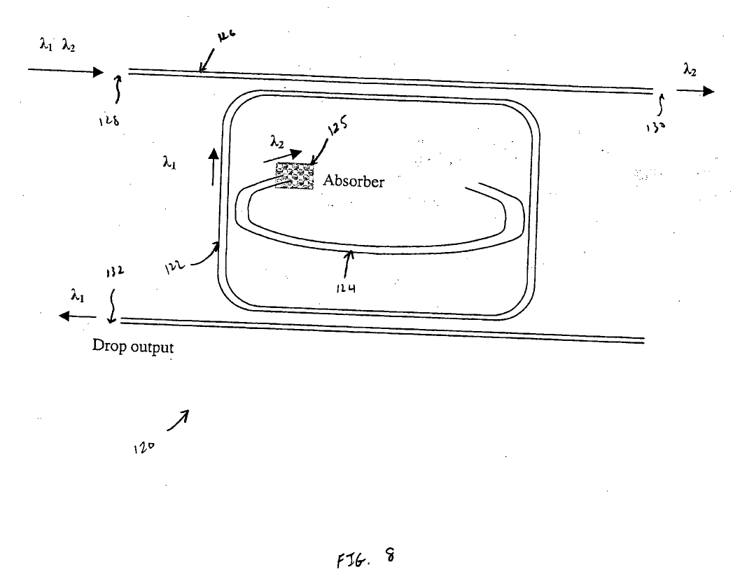

FIGS. 9A-9C are schematic diagrams of a switchable and tunable filter arrangement 134. FIGS. 9A-9B show a filter arrangement 134 having three ring resonators 136 and an interferometric device 138 that is positioned on the left side of the center ring 146. Moreover, the filter arrangement 134 includes a main bus line 140 having an input port 142 that receives a plurality of channels λ₁, λ₂, and λ₃, and the main bus line also includes a throughput port 144. In this case, the interferometric device 138 is an unbalanced MZI structure that is thermally controlled. FIG. 9A shows that MZI structure 138 is set at a temperature of T₀, which allows wavelength λ₁ to be dropped. As shown in FIG. 9B, it is possible to set the temperature of the MZI structure 146 at T_{switching}. In this way the wavelength response of the MZI does not match with any of the resonant peaks of the resonant cavities amid the desired FSR. No wavelength will resonate and thus all the channels will be present at the throughput port 144. The filter arrangement is basically a switch for the wavelength response λ₁, where at temperature T₀ the switch is turned off and at temperature T_{switching} the switch is open.

FIG. 9C shows a filter arrangement 148, which is similar to that described in FIGS. 9A-9B. The MZI structure 150 is thermally controlled as in FIG. 9B. This control provides the ability to control the MZI response in order to match its response with a different resonant peak of the resonant cavities. In this case, the MZI structure 150 is tuned at a temperature T_{tuning} to match the wavelength response of λ₂. Other wavelength responses can be matched by adjusting conveniently T_{tuning}.

The advantages of the filter arrangements 134, 148 described for FIGS. 9A-9C are its simplicity and ease of realization. In addition, the mechanism can be used for tuning and switching. Tuning mechanisms other than thermal tuning can be envisaged. For example, the refractive index (and path length) of one of the arms of the MZI can be changed by applying a suitable electric field, if an electro-optic material is used for part of or all of the MZ interferometer.

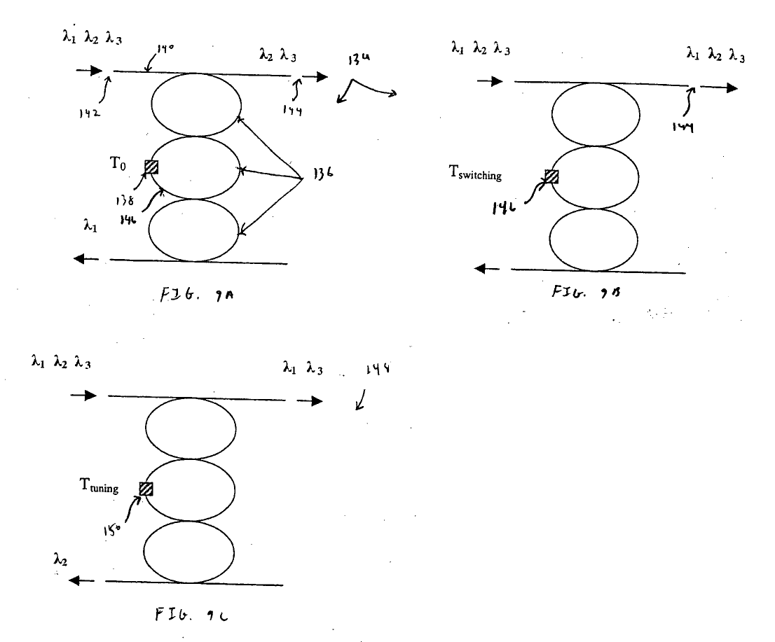

FIG. 10 is a schematic diagram of another embodiment of a switchable and/or tunable filter arrangement 152. The filter arrangement 152 includes a three separate filter arrangements 154, 156, 158, and a main bus line 178 having an input port 180 and a throughput port 182. However, in other embodiments there can be n separate filter arrangements. The input port 180 includes a plurality of channels λₗ. . . λₙ. Each of the filter arrangements 154, 156, 158 includes three ring resonators 160, 162, 164 and a thermally controlled MZI structure 172, 174, 176 that is interferometric. Also, each of the filter arrangements 154, 156, 158 includes a separated input/output ports 166, 168, 170 for add and drop operations.

Each of the MZI structures 172, 174, 176 is assigned a temperature that can be tuned. Depending on the temperature imposed on the MZI structures 172, 174, and 176, the filters 172, 174, and 176 could be switched ON or OFF. This is an example of a switchable filter. In this case, the MZI structure 172 at temperature T1 matches its wavelength response λ₁, which removes the wavelength λ₁ from propagating to the throughput port 182. The other MZI structures 174, 176 are not matched with their associated wavelength response. However, in other embodiments, any number of the MZI structures 174, 176 can be matched, thus rejecting selective wavelength responses from the channels of the input port 180.

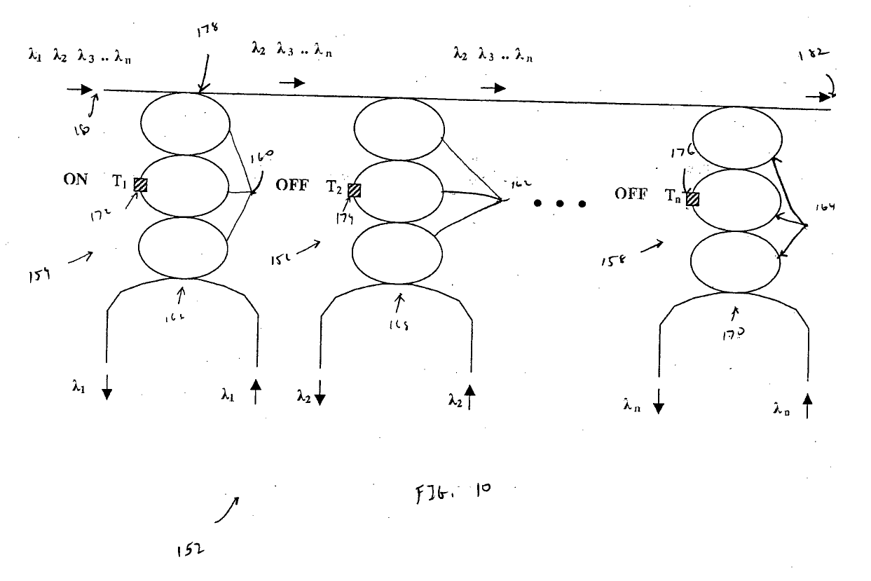

FIG. 11 is a schematic diagram of a second embodiment of the switchable and tunable filter arrangement 184. The filter arrangement 184 is similar to the filter arrangement described 152 in FIG. 10. However, input/output ports 186, 188, 190 can input more than one wavelength. This permits to choose which wavelength has to be filtered out or rejected. The MZI structures 192, 194, 196 will need to be tuned to the correct temperature to permit the rejection of the correct wavelength.

Also for the embodiments of FIGS. 10 and 11, switching mechanisms other than thermal switching can be adopted, e.g., electro-optic switching.

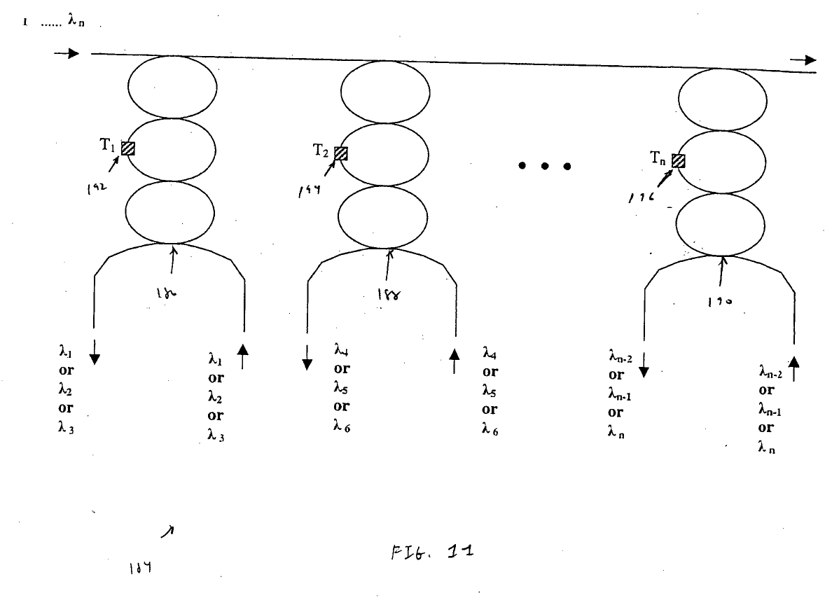

FIG. 12 is a schematic diagram of a first embodiment of the switchable and tunable laser 198. The filter arrangement 198 includes an isolator 200, a gain material 202, two filter arrangements 204, 208, main bus line 210, and a second bus line 218. The main bus line 210 includes an input port 212 and throughput port 214. The filter arrangements 204, 208 are comprised of two three-ring structures 220, 222, and each filter arrangement 204, 206 can include a controlled (e.g., thermally controlled) unbalanced MZI structure 224, 226. The input port 212 includes channels λ₁ . . . λₙ. The isolator 200 is used to maintain consistency amongst channels propagating from the first filter arrangement 204 to the second filter arrangement 208 so that no backward propagation occurs.

The MZI structures 224, 226 are tuned to a specific wavelength response so that it is possible to choose the lasing wavelength of the laser.

Laser 198 is a ring laser. The electromagnetic radiation emitted by gain material 202 circulates in one direction in the ring cavity, thanks to isolator 200, is amplified by gain material 202 and at each pass, and a fraction of it leaves the cavity thanks to filter arrangement 208, that partly transmits the radiation to throughput port 214. The spectral response of filter arrangements 204, 208 is selected so as to result in transmission for the desired laser emission frequency and in hindered resonance through the ring cavity for other frequencies. The emission frequency of the laser can be tuned by acting on the control of MZIs 220, 222. Moreover, a tuning element (e.g., thermally controlled), not shown, can be provided along the ring path, e.g., between gain material 202 and filter arrangement 220, to vary the path length of the resonating ring path. In this way, the lasing wavelength or frequency can be tuned, trimmed or switched.

If signals at different wavelengths are present at input port 212, they will propagate through the main bus line 210 to throughput port 214, thanks to the spectral response of filter arrangements 204, 208. Moreover, a signal at a new wavelength, generated by laser 198, will be present at throughput port 214 together with any throughput wavelength, so that the structure operates at the same time as a laser and as an add filter.

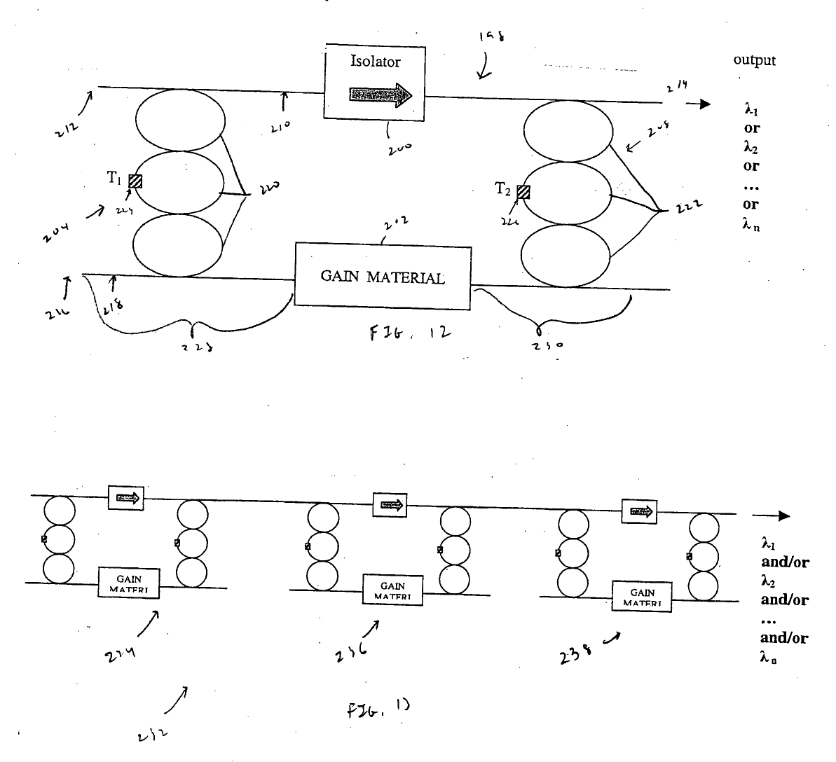

FIG. 13 is a schematic diagram of a second embodiment of a switchable and tunable laser arrangement 232. In particular, FIG. 13 shows a cascade of various laser arrangements 234, 236, 238. Each of these filter arrangements 234, 236, 238 is similar to the filter arrangement 198 described in FIG. 12.

The filter arrangements 234, 236, 238 can have any number of rings and different configurations. Depending on the application, all of the rings of a filter arrangement 234, 236, 238 can have a nested optical device or only few. The nested optical device is positioned along the optical path of a ring.

The invention can be used in both integrated optics devices, such as planar waveguides, or fiber optics. The advantage of the inventive filter is that the FSR is no more strictly linked with the FSR of the single rings that compose the whole filter. Moreover, it is possible to have long rings with high FSR, for example, 300 μ/m long rings to obtain 40 nm FSR. The invention also allows low contrast index waveguides to be used and at the same time to have high FSR, because the invention has eliminated the need for very short rings with very tight bends. The bandwidth of the filter is not anymore strictly linked with the FSR. In fact, if the desired FSR is fixed, it is possible to vary the length of the rings and thus the overall bandwidth. Furthermore, all fabrication steps can be relaxed if big dimensions are used.

The ring structures described throughout can be comprised of different materials, such as SiO₂:Ge for the waveguide and SiO₂ for the cladding or SiON for the waveguide and SiO₂ for the cladding or Si₃N₄ for the waveguide and SiO₂ for the cladding. Other material combinations can be used in accordance with the invention.

Furthermore, the invention can be used with optical fibers or Planar Lightwave Circuits (PLCs). The invention can significantly improve the performance of optical signals traveling in these structures.

Although the present invention has been shown and described with respect to several preferred embodiments thereof, various changes, omissions and additions to the form and detail thereof, may be made therein, without departing from the spirit and scope of the invention.

1. An optical filter comprising:
at least one ring resonator that is apt to receive as input an optical signal having a plurality of channels from an input optical source; and
at least one unbalanced Mach-Zehnder module nested in said at least one ring resonator, wherein said at least one unbalanced Mach-Zehnder module and said at least one ring resonator are apt to filter at least one selective channel from said optical signal.

2. The optical filter of claim 1, wherein said at least one unbalanced Mach-Zehnder module comprises an absorber.

3. The optical filter of claim 1, wherein said at least one ring resonator comprises two or more ring resonators.

4. The optical filter of claim 3, wherein said at least one unbalanced Mach-Zehnder module comprises three unbalanced MZI structures.

5. The optical filter of claim 3, wherein said at least one unbalanced Mach-Zehnder module comprises two unbalanced MZI structures.

6. The optical filter of claim 1, wherein said at least one ring resonator comprises a SiO₂:Ge waveguide and SiO₂ cladding.

7. The optical filter of claim 1, wherein said at least one ring resonator comprises a SiON waveguide and SiO₂ cladding.

8. The optical filter of claim 1, wherein said at least one ring resonator comprises a Si₃N₄ waveguide and SiO₂ cladding.

9. The optical filter of claim 1 further comprising a tuning mechanism for tuning the properties of said optical filter.

10. The optical filter of claim 9, wherein said tuning mechanism tunes the properties of the optical filter thermally.

11. The optical filter of claim 9, wherein said tuning mechanism tunes the properties of the optical filter using electro-optic effect.

12. The optical filter of claim 1, wherein said optical filter is implemented in a fiber optical system.

13. The optical filter of claim 1, wherein said optical filter is implemented in a Planar Lightwave Circuit.

14. The optical filter of claim 1, wherein said at least one unbalanced MZI module is implemented along one arm of said least one ring resonator.

15. The optical filter of claim 1, wherein said at least one unbalanced MZI module is implemented along two arms of said least one ring resonator.

16. An optical filter comprising:
a plurality of filter arrangements including at least one ring resonator that is apt to receive as input an optical signal having a plurality of channels from an input optical source; and
at least one unbalanced Mach-Zehnder module nested in said at least one ring resonator, wherein said at least one unbalanced Mach-Zehnder module and said at least one ring resonator are apt to filter at least one selective channel from said optical signal.

17. The optical filter of claim 16, wherein said at one ring resonator comprises two or more ring resonators.

18. The optical filter of claim 17, wherein said at least one unbalanced Mach-Zehnder module comprises three unbalanced MZI structures.

19. The optical filter of claim 17, wherein said at least one unbalanced Mach-Zehnder module comprises two unbalanced MZI structures.

20. The optical filter of claim 16, wherein said at least one ring resonator comprises a SiO₂:Ge waveguide and SiO₂ cladding.

21. The optical filter of claim 16, wherein said at least one ring resonator comprises a SiON waveguide and SiO₂ cladding.

22. The optical filter of claim 16, wherein said at least one ring resonator comprises a Si₃N₄ waveguide and SiO₂ cladding.

23. The optical filter of claim 16 further comprising a tuning mechanism for tuning the properties of said optical filter.

24. The optical filter of claim 23, wherein said tuning mechanism tunes the properties of the optical filter thermally.

25. The optical filter of claim 23, wherein said tuning mechanism tunes the properties of the optical filter using electro-optic effect.

26. The optical filter of claim 16, wherein said optical filter is implemented in a fiber optical system.

27. The optical filter of claim 16, wherein said optical filter is implemented in a Planar Lightwave Circuit.

28. The optical filter of claim 16, wherein said at least one unbalanced MZI module is implemented along one arm of said least one ring resonator.

29. The optical filter of claim 16, wherein said at least one unbalanced MZI module is implemented along two arms of said least one ring resonator.

30. A method of optical filtering, said method comprising:
providing at least one ring resonator that receives as input an optical signal having a plurality of channels from an input optical source; and
providing at least one unbalanced Mach-Zehnder module nested in said at least one ring resonator, wherein said at least one unbalanced Mach-Zehnder module and said at least one ring resonator filtering at least one selective channel from said optical signal.

31. The method of claim 30, wherein said at least one unbalanced Mach-Zehnder module comprises an absorber.

32. The method of claim 30, wherein said at one ring resonator comprises two or more ring resonators.

33. The method of claim 32, wherein said at least one unbalanced Mach-Zehnder module comprises three unbalanced MZI structures.

34. The method of claim 32, wherein said at least one unbalanced Mach-Zehnder module comprises two unbalanced MZI structures.

35. The method of claim 30, wherein said at least one ring resonator comprises a SiO₂:Ge waveguide and SiO₂ cladding.

36. The method of claim 30, wherein said at least one ring resonator comprises a SiON waveguide and SiO₂ cladding.

37. The method of claim 30, wherein said at least one ring resonator comprises a Si₃N₄ waveguide and SiO₂ cladding.

38. The method of claim 30 further comprising tuning the properties of said optical filter.

39. The method of claim 38, wherein said tuning the properties of the optical filter is done thermally.

40. The method of claim 38, wherein said tuning the properties of the optical filter is done using electro-optic effect.

41. The method of claim 30, wherein said optical filter is implemented in a fiber optical system.

42. The method of claim 30, wherein said optical filter is implemented in a Planar Lightwave Circuit.

43. The method of claim 30, wherein said at least one unbalanced MZI module is implemented along one arm of said least one ring resonator.

44. The method of claim 30, wherein said at least one unbalanced MZI module is implemented along two arms of said least one ring resonator.

45. A method of optical filtering, said method comprising:
providing a plurality of filter arrangement including at least one ring resonator that receives as input an optical signal having a plurality of channels from an input optical source; and
providing at least one unbalanced Mach-Zehnder module nested in said at least one ring resonator, wherein said at least one unbalanced Mach-Zehnder module and said at least one ring resonator filtering at least one selective channel from said optical signal.

46. The method of claim 45, wherein said at one ring resonator comprises two or more ring resonators.

47. The method of claim 46, wherein said at least one unbalanced Mach-Zehnder module comprises three unbalanced MZI structures.

48. The method of claim 46, wherein said at least one unbalanced Mach-Zehnder module comprises two unbalanced MZI structures.

49. The method of claim 45, wherein said at least one ring resonator comprises a SiO₂:Ge waveguide and SiO₂ cladding.

50. The method of claim 45, wherein said at least one ring resonator comprises a SiON waveguide and SiO₂ cladding.

51. The method of claim 45, wherein said at least one ring resonator comprises a Si₃N₄ waveguide and SiO₂ cladding.

52. The method of claim 45 further comprising tuning the properties of said optical filter.

53. The method of claim 52, wherein said tuning the properties of the optical filter is done thermally.

54. The method of claim 52, wherein said tuning the properties of the optical filter is done using electro-optic effect.

55. The method of claim 45, wherein said optical filter is implemented in a fiber optical system.

56. The method of claim 45, wherein said optical filter is implemented in a Planar Lightwave Circuit.

57. The method of claim 45, wherein said at least one unbalanced MZI module is implemented along one arm of said least one ring resonator.

58. The method of claim 45, wherein said at least one unbalanced MZI module is implemented along two arms of said least one ring resonator.
